(19) United States
(12) Patent Application Publication
(10) Pub. No.: US 2026/0018805 A1
(43) Pub. Date: Jan. 15, 2026

(54) Method and Apparatus for producing a friction-welded connection and an electrical arrangement produced thereby

(71) Applicant: NEXANS, Courbevoie (FR)

(72) Inventors: Ulrich DOELLINGER, FLOSS (DE); Helmut STEINBERG, STÖRNSTEIN (DE)

(21) Appl. No.: 19/265,516

(22) Filed: Jul. 10, 2025

(30) Foreign Application Priority Data
Jul. 12, 2024 (DE) 102024119869.9

(51) Int. Cl. H01R 4/02; B23K 20/12; H01R 43/02

(52) U.S. Cl. CPC H01R 4/027; B23K 20/129; H01R 43/0263

(57) ABSTRACT

A method is provided for producing a friction-welded connection between two electrical conductors by means of a connecting cylinder. The electrical conductors are pressed against contact surfaces of the connecting cylinder (103) which is set in rotation. Furthermore, an electrical arrangement is provided which is produced according to this method, and an apparatus is provided which is suitable for performing the method.

### RELATED APPLICATION

This application claims the benefit of priority from German Patent Application No. 10 2024 119869.9 filed on Jul. 12, 2024, the entirety of which is incorporated by reference.

### FIELD

The invention relates to a method for producing a connection between two electrical conductors, and furthermore to an apparatus for producing such a connection.

### BACKGROUND

In the case of purely electric or hybrid powered vehicles, high current strengths in the magnitude of up to 300 A are transmitted for charging a vehicle battery and for driving one or multiple drive motors. Busbars with a solid conductor are often used to transmit these high current strengths. For example, busbars lead from a charging socket on an electrically powered vehicle to a rechargeable battery located in the lower region of the vehicle. To ensure that the charging socket is easily accessible for a user of the vehicle when connecting a charging cable, the charging socket is located at a height of approximately 1 m, while the battery is located at a lower level at the height of the vehicle floor. The height difference between the charging socket and battery frequently require the busbars to have a three dimensional shape. In many cases, a three-dimensionally shaped busbar can no longer be welded to a second connection partner by friction welding because it is usually impossible to rotate one of the two parts to be connected, namely the busbar and the connection partner. Similar problems arise in the case of busbars which connect the vehicle battery to one or more drive motors. Conventionally, these problems are resolved by arranging at the ends of the busbars screw or plug contacts which are connected to one another. The connection site is also enclosed by a housing which protects the connection site against environmental influences.

Based on this, the object of the present invention is to propose a method for producing a connection between two electrical conductors and to propose an apparatus for carrying out the method in order to overcome or at least improve one or more of the problems mentioned at the beginning.

### DESCRIPTION OF THE INVENTION

In order to achieve this object, the invention proposes according to a first aspect a method for connecting two electrical conductors by means of a connecting cylinder which has two base surfaces and a sheath surface. The method comprises
pressing the electrical conductors against a respective contact surface of the connecting cylinder, wherein the surface normals of the contact surfaces are oriented parallel to the axis of symmetry of the connecting cylinder;
rotating the connecting cylinder until the connecting cylinder forms a material-bonded connection, in particular a friction-welded connection, with the electrical conductors;
terminating the rotation of the connecting cylinder.

The proposed method is characterized in that a connecting cylinder is inserted between two partners that are to be connected. The proposed method is therefore especially advantageous in application cases when it is not possible to rotate one of the two connection partners. A specific application case is, for example, the connection of busbars in an electric vehicle. The busbars in an electric vehicle frequently have a 3-dimensional shape for adaptation to a given installation path.

In accordance with an advantageous development, the method also comprises:
attaching two support rollers to the connecting cylinder;
placing a pressure roller against the connecting cylinder so that the connecting cylinder is pressed against the support rollers;
driving the pressure and/or the support rollers in order to set the connecting cylinder in rotation;
stopping the driven pressure and/or support rollers in order to produce a friction-welded connection between the connecting cylinder and the electrical conductors.

The combination of the pressure and support rollers renders it possible to rotate the connecting cylinder in a simple manner.

In an expedient manner, the method can also comprise:
raising the pressure roller from the connecting cylinder; and
removing the support rollers from the connecting cylinder.

Once the pressure and/or support rollers have been removed from the connecting cylinder, it is possible to remove an apparatus which has been used during production.

According to a second aspect, an electrical arrangement with two electrical conductors is proposed, which are respectively connected by means of a friction-welded connection to a connecting cylinder.

The connecting cylinder can be rotated so that a friction-welded connection can be realized to one of the electrical conductors respectively. It is possible in this manner to connect electrical conductors to one another in a simple manner even when these conductors cannot be rotated, for example, when busbars are involved.

In the case of an expedient development, the connecting cylinder is designed as a solid full cylinder.

In the case of an advantageous exemplary embodiment, the electrical conductors have a rectangular cross-section, wherein the diameter of the connecting cylinder is selected such that the base surfaces of the connecting cylinder respectively assume the entire end-side cross-sectional area of the two conductors. The selection of the dimensioning in this manner ensures that the entire conductor cross-section is used for the current transmission.

In an alternative exemplary embodiment, the connecting cylinder has a centred blind hole in at least one of its base surfaces.

When the connecting cylinder has only one blind hole, the bottom of this blind hole forms a contact surface for a conductor which can be inserted into this blind hole. The cross-section of this conductor could be either circular or rectangular. The only important thing is that the conductor can be brought into frictional contact with the bottom of the blind hole. In embodiments with two blind holes which are arranged in a respective one of the base surfaces of the connecting cylinder, the blind holes are separated from one another by a partition wall. The two sides of the partition wall form a respective contact surface for the inserted electrical conductors. A connecting cylinder with two blind holes is also referred to below as a connecting sleeve. The connecting sleeve can be centred on the conductors in a simpler manner in comparison to a connecting cylinder with only one or even no blind hole.

In the case of an expedient embodiment, at least one of the two conductors has a circular cross-sectional area, and wherein the at least one conductor is designed as a solid conductor or as a stranded conductor.

In accordance with one embodiment of the electrical arrangement, it is also possible, for example that a busbar with a solid conductor, which has a circular or rectangular cross-section, is welded to a round stranded conductor. The stranded conductor is mechanically flexible and has advantages during assembly and in application cases in which components connected to the busbar move at least slightly relative to one another, as is the case, for example, in the case of a drive motor in an electric vehicle.

In accordance with a third aspect of the invention, an apparatus for rotating the connecting cylinder is proposed in order to connect two electrical conductors respectively to the connecting cylinder. The apparatus has two support rollers and one pressure roller that can be adjusted by means of an actuator. The pressure roller and/or the support rollers can be driven in order to set them in rotation.

In an advantageous exemplary embodiment, the apparatus is arranged on a robotic arm in order in the case of busbars which are already mounted in a vehicle or in an installation to move the apparatus the connection site of the busbars.

In an expedient development, the apparatus can have holding means for the electrical conductors, the holding means being configured so as to press the electrical conductors against contact surfaces of the connecting cylinder.

The holding means generate a thrusting force which presses the electrical conductors against contact surfaces of the connecting cylinder in order to friction weld the busbars to the connecting cylinder.

### SHORT DESCRIPTION OF THE DRAWING

The invention is explained in detail in an exemplary manner with the aid of an embodiment with reference to the accompanying figures. All the figures are purely schematic and not to scale. In the drawing:

FIG. 1 shows a perspective view of two electrical lines connected to one another;

FIG. 2 shows a cross-sectional view of the electrical lines from FIG. 1;

FIG. 3 shows a cross-sectional view of electrical lines which are connected by means of a full cylinder;

FIG. 4A shows a perspective, greatly schematic representation of an apparatus for producing a connection between two electrical conductors;

FIGS. 4B,C show a cross-sectional view of the apparatus from FIG. 4A in a charging position or working position;

FIGS. 5A, 5B show an apparatus for producing a friction-welded connection in accordance with the present invention; and

FIG. 6 shows a flow diagram for producing a friction-welded connection between two conductors according to the method in accordance with the invention.

Identical or similar elements are provided in the figures with identical or similar reference characters.

### Exemplary Embodiment

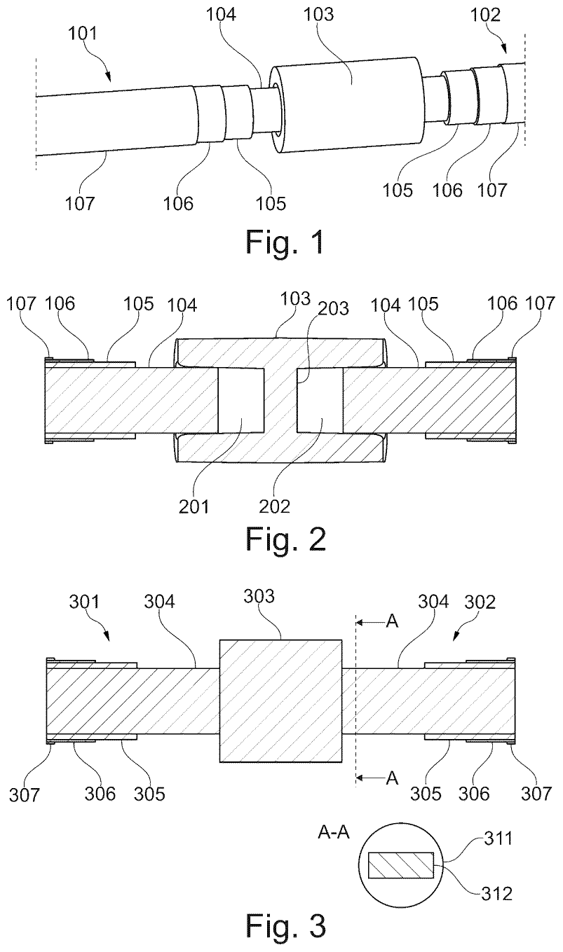

FIG. 1 shows a perspective view of an electrical arrangement 100 with two electrical lines 101, 102 which are connected to one another by a connecting sleeve 103. The electrical lines 101, 102 are constructed identically and have a conductor 104, an inner insulation 105, a shield 106 and an outer sheath 107. In the case of an exemplary embodiment, the cross-section of the conductor is 95 mm². However, the cross-section can also be larger or smaller than 95 mm² in the case of other exemplary embodiments. The axial length of the connecting sleeve 103 is 40-50 mm for example. The setback length of the conductor 104 corresponds to approximately half the axial length of the connecting sleeve 103, whereas the setback lengths of the inner insulation 105, the shield 106 and the outer sheath 107 are significantly shorter and are only represented in an exaggerated manner in FIG. 1 for better illustration.

FIG. 2 shows the cylindrical connecting sleeve 103 in the cross-section. The connecting sleeve 103 has two blind holes 201, 202 into which the lines 101, 102 have not yet been fully inserted in order to be able to better depict the structural construction of the connecting sleeve 103 graphically. The blind holes are separated from one another by a partition wall 203. In order to produce a material-bonded connection between the conductors 104 of the lines 101, 102, the conductors 104 are inserted fully into the connecting sleeve until their end-side ends respectively lie against the partition wall 203. In order to weld the conductors 104 to the connecting sleeve 103, the connecting sleeve 103 is set in rotation until the material of the conductor 104 and the connecting sleeve 103 achieve a flowable state and penetrate one another. As soon as this state is achieved, the rotation of the connection sleeve 103 is terminated resulting in a permanent welded connection between the connecting sleeve 103 and the conductors 104. The friction-welded connection produced in this manner is dependent upon the material from which the conductors and connecting sleeve are made. In most cases, copper or aluminium are used for this purpose, wherein the welded connection can also be realized with any material combinations. For this purpose, it is only necessary for the parameters to match the speed of rotation, duration of rotation and insertion pressure of the conductors 104.

The conductors 104 can be designed as solid conductors or stranded conductors. Solid conductors have advantages when transmitting current, whereas due to their mechanical flexibility stranded conductors are advantageous when connecting a battery terminal or a terminal to a drive motor, for example. The proposed connection technology between solid conductors and stranded conductors is cost effective and widens the use of busbars with solid conductors in application cases in which the mechanical flexibility of a stranded conductor is desired or required during assembly or operation.

The electrical conductors have a round cross-section in the exemplary embodiments described. In the case of a modified embodiment shown in FIG. 3, it is also possible to connect other busbars with any conductor cross-sections, in particular busbars with a rectangular conductor cross-section, which have advantages in comparison with round conductor cross-sections during installation for specific application cases.

FIG. 3 shows a cross-sectional view of two electrical lines 301, 302 which are connected to one another by a connecting cylinder 303. The electrical lines 301, 302 have rectangular conductors 304, an inner insulation 305, a shield 306 and an outer sheath 307. The conductors 304 are placed with their stripped ends flush against the base surfaces 308, 309 of the connecting cylinder 303. The diameter of the connecting cylinder 303 is selected such that both conductors 304 stand with their entire end-side cross-sectional area on a respective base surface of the connecting cylinder 303. A section shown in FIG. 3 shows a cut along line A-A, in which the base surface of the connecting cylinder 303 is represented by a circle 311 and the cross-sectional area of a conductor 304 is represented by a rectangle 312. In cases in which electrical lines 301, 302 with different conductor cross-sections are used, the diameter of the connecting cylinder 303 is oriented on the larger conductor cross-section. The connecting cylinder 303 is set in rotation and stopped after a predetermined period of time. In so doing, a friction-welded connection is produced between the connecting cylinder 303 and the conductors 304. Of course, a connecting cylinder 303 can also be used to connect conductors with a circular cross-section. However, a connecting sleeve 103 is easier to centre on the conductors to be connected than a connecting cylinder 303, which is designed as a full cylinder.

In the case of a further exemplary embodiment not illustrated in the drawing, a connecting cylinder does not have two but rather only one blind hole in one of its base surfaces in order to receive a conductor. Conductors with either a circular or rectangular cross-section can be received in the blind hole. This connecting cylinder is also slightly easier to centre than a full cylinder, although not as easy as a connecting sleeve 103.

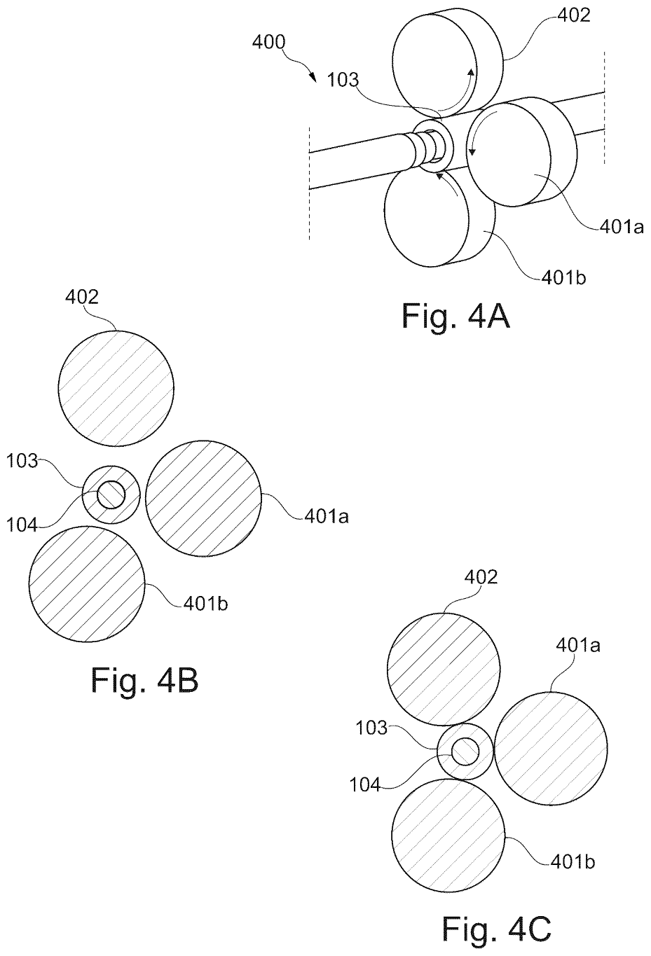

FIG. 4A shows in a perspective representation an apparatus 400 which sets the connecting sleeve 103 in rotation by means of driven support rollers 401a, 401b and a pressure roller 402. The bearing and the drive of the support and pressure rollers have been omitted for clarity.

FIG. 4B shows a cross-sectional view of the initial phase of the production of the mature welded connection between the connecting sleeve 103 and the conductors 104 of the lines or busbars 101, 102. The pressure roller 402 is moved into an open charging position by means of an actuator (not illustrated) so that the lines 101, 102 can be placed between the pressure and support rollers. The pressure roller 402 is then moved into a closed working position as is illustrated in FIG. 4C. In the working position, the pressure and support rollers 402, 401a, 401b lie against the outer periphery of the connecting sleeve 103 and the driven support rollers 401a, 401b set the connecting sleeve 103 in rotation in order to produce in the described manner a friction-welded connection between the conductors 104 of the lines 101, 102 and the connecting sleeve 103.

As soon as the friction-welded connections have been produced, the pressure roller 402 moves back into the open charging position shown in FIG. 4B and the apparatus 400 is removed from the connecting site.

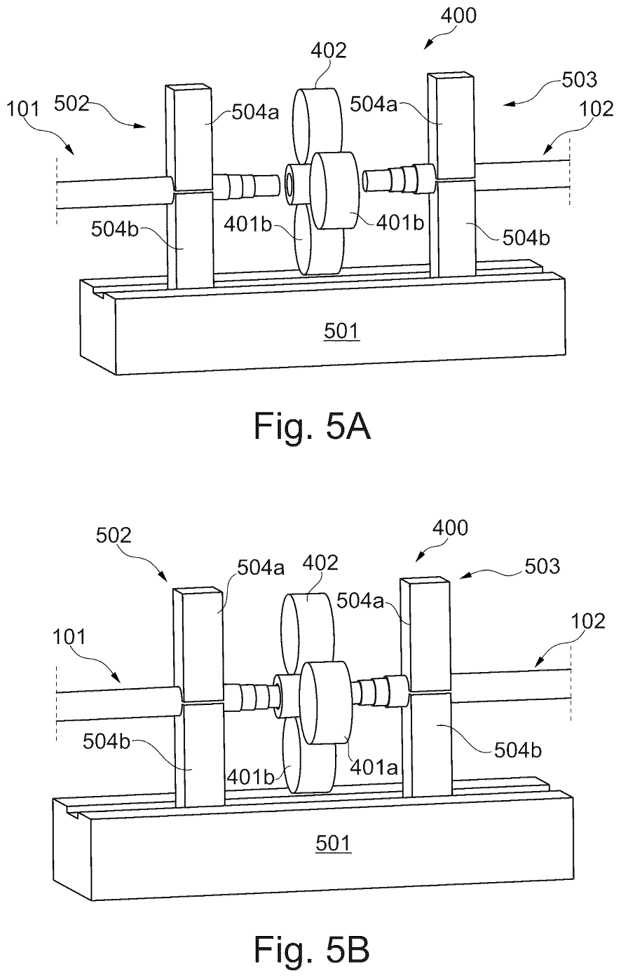

FIG. 5A shows a further aspect of the apparatus 400 in a schematic representation. The support and pressure rollers 401a,b, 402 are already in the working position in this representation. The apparatus has a bed 501 in which clamping means 502, 503 can be moved in the longitudinal direction. The clamping means 502, 503 have respectively two clamping jaws 504a, 504b between which the line 101 or 102 respectively can be clamped. The two clamping means 502, 503 are then moved towards one another until the conductors 104 of the lines 101 or 102 respectively contact a contact surface of the connecting sleeve 103. This state is shown in FIG. 5B. The support rollers 401a, 401b are subsequently set in rotation in order to produce the friction-welded connections between the connecting sleeve 103 and the conductors 104, as has already been described above.

In one exemplary embodiment, the bed 501 is mounted on a robotic arm so that, in order to produce the friction-welded connections when assembling electrical installations or electric vehicles, the apparatus can be moved in a simple manner to the position where the friction-welded connections are to be produced.

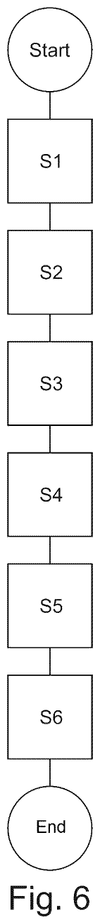

Finally, FIG. 6 shows a flow diagram for producing a friction-welded connection between two conductors according to the method in accordance with the invention. In a first step S1, two electrical conductors are pressed against a respective contact surface of a connecting cylinder. In step S2, the two support rollers 401a,b are placed against the connecting cylinder. Then, in step S3, the pressure roller 402 is pressed against the connecting sleeve 103. Subsequently, in step S4, the pressure and/or support rollers are driven and as a result set in rotation. Subsequently, in step S5, the driven pressure and/or support rollers are stopped and in step S6 removed from the connecting sleeve 103. The method is performed in the same manner when in lieu of the connecting sleeve 103 a connecting cylinder without or with one blind hole or with two blind holes is used.

Although the invention has been described with reference to busbars installed in electric vehicles, the invention is not limited to this type of application, but can rather be used in all types of electrical installations where busbars need to be connected to one another.

### LIST OF REFERENCE CHARACTERS

100 Electrical arrangement
101, 102 Electrical line
103 Connecting sleeve
104 Conductor
105 Inner insulation
106 Shield
107 Outer sheath
201, 202 Blind hole
203 Partition wall
301, 302 Electrical line
303 Connecting cylinder
304 Conductor
305 Inner insulation
306 Shield
307 Outer sheath
308, 309 Base surfaces
311 Circle
312 Rectangle
400 Apparatus
401a,b Support rollers
402 Pressure roller
501 Bed
502, 503 Clamping means
504a,b Clamping jaws

1. A method for connecting two electrical conductors by means of a connecting cylinder, which has two base surfaces and a sheath surface, said the method comprising the steps of:
pressing the electrical conductors against a respective contact surface of the connecting cylinder, wherein the surface normals of the contact surfaces are oriented parallel to the axis of symmetry of the connecting cylinder;
rotating the connecting cylinder until the connecting cylinder forms a material-bonded connection, in particular a friction-welded connection, with the electrical conductors; and
terminating the rotation of the connecting cylinder.

2. The method according to claim 1, wherein the method also comprises:
attaching two support rollers to the connecting cylinder;
placing a pressure roller against the connecting cylinder so that the connecting cylinder is pressed against the support rollers;
driving the pressure and/or the support rollers in order to set the connecting cylinder in rotation; and
stopping the driven pressure and/or support rollers in order to produce a friction-welded connection between the connecting cylinder and the electrical conductors.

3. The method according to claim 1, wherein the method also comprises:
raising the pressure roller from the connecting cylinder; and
removing the support rollers from the connecting cylinder.

4. An electrical arrangement with two electrical conductors which are connected to a connecting cylinder respectively by means of a friction-welded connection.

5. The electrical arrangement according to claim 4, wherein the connecting cylinder is designed as a solid full cylinder.

6. The electrical arrangement according to claim 5, wherein the electrical conductors have a rectangular cross-section, wherein the diameter of the connecting cylinder is selected such that the base surfaces of the connecting cylinder respectively assume the entire end-side cross-sectional area of the two conductors.

7. The electrical arrangement according to claim 4, wherein the connecting cylinder has a centred blind hole in at least one of its base surfaces.

8. The electrical arrangement according to claim 4, wherein at least one of the two conductors has a circular cross-sectional area, and wherein the at least one conductor is designed as a solid conductor or as a stranded conductor.

9. An apparatus for rotating a connecting cylinder in order to connect two electrical conductors respectively to the connecting cylinder, wherein the apparatus has two support rollers and a pressure roller which can be adjusted by means of an actuator and wherein the pressure roller and/or the support rollers can be driven in order to set them in rotation.

10. The apparatus according to claim 9, wherein the apparatus has holding means for the electrical conductors, the holding means being configured so as to press the electrical conductors against contact surfaces of the connecting cylinder.
